(19) United States
(12) Patent Application Publication
(10) Pub. No.: US 2004/0216096 A1
(43) Pub. Date: Oct. 28, 2004

(54) Partitioning of structured programs

(76) Inventors: Alan Messer, Los Gatos, CA (US); Ira Greenberg, Mountain View, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/425,063

(22) Filed: Apr. 28, 2003

(51) Int. Cl. G06F 9/45; G06F 9/44

(52) U.S. Cl. 717/154; 717/130

(57) ABSTRACT

Partitioning of programs that exploits the granularity of structured programs and enables partitioning and re-partitioning of a program at run-time. A run-time executable is partitioned according to the present techniques by building a graph of an execution history of the run-time executable such that the graph includes a set of nodes each corresponding to a software component of the run-time executable and a set of weighted edges that indicate a level of interaction among the software components. A set of intermediate partitionings of the nodes is then determined in response to the weighted edges and one of the intermediate partitionings is selected that meets a partitioning goal.

### BACKGROUND OF THE INVENTION

1. Field of Invention The present invention pertains to the field of software programs. More particularly, this invention relates to partitioning of software programs.

2. Art Background

A wide variety of application programs exist examples of which are too numerous to mention. A provider of an application program typically generates a run-time version of the application program. A run-time version of an application program typically takes the form of a set of executable code that is adapted to a particular execution platform. An execution platform is typically characterized by a particular set of hardware resources such as processor, memory, etc. as well as a particular operating system. A run-time version of an application program may be referred to as a run-time executable.

It is often desirable to partition a run-time executable so that it may be executed on multiple execution platforms. For example, it may be desirable to partition a run-time executable because a single execution platform has insufficient memory space to hold the entire run-time executable. Other possible motivations for partitioning a run-time executable among multiple execution platforms may include a desire to improve execution performance, a desire to reduce power consumption on individual execution platforms, or a desire to prevent resource overload on individual execution platforms.

Prior methods for partitioning a program typically include manual partitioning that adapts partitions to a particular arrangement of execution platforms onto which the application program is to be deployed. Unfortunately, such methods usually yield run-time code for one particular arrangement of execution platforms that may not be easily redeployed to other arrangements. Moreover, such methods usually cannot adapt the partitioning to changes in the execution environment such as the addition of other applications, increases in network traffic, installation of new hardware or software, etc. Furthermore, manual partitioning is usually time-consuming and may lead to a non-optimal solution.

### SUMMARY OF THE INVENTION

Partitioning of programs is disclosed that exploits the language granularity implicitly found in structured programs and enables partitioning and re-partitioning of a program at run-time. A run-time executable is partitioned according to the present techniques by building a graph of an execution history of the run-time executable such that the graph includes a set of nodes each corresponding to a software component of the run-time executable and a set of weighted edges that indicate a level of interaction among the software components. A set of intermediate partitionings of the nodes is then determined in response to the weighted edges and one of the intermediate partitionings is selected that meets a partitioning goal. The software components may then be distributed accordingly.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows one embodiment of a software execution system that partitions a run-time executable according to the present teachings;

FIG. 2 illustrates an execution graph that a partitioner builds from the information contained in an execution history in one embodiment;

FIG. 3 shows a method for partitioning a run-time executable according to one embodiment of the present techniques;

FIG. 4 shows a method for run-time partitioning of a run-time executable according to one embodiment of the present techniques.

### DETAILED DESCRIPTION

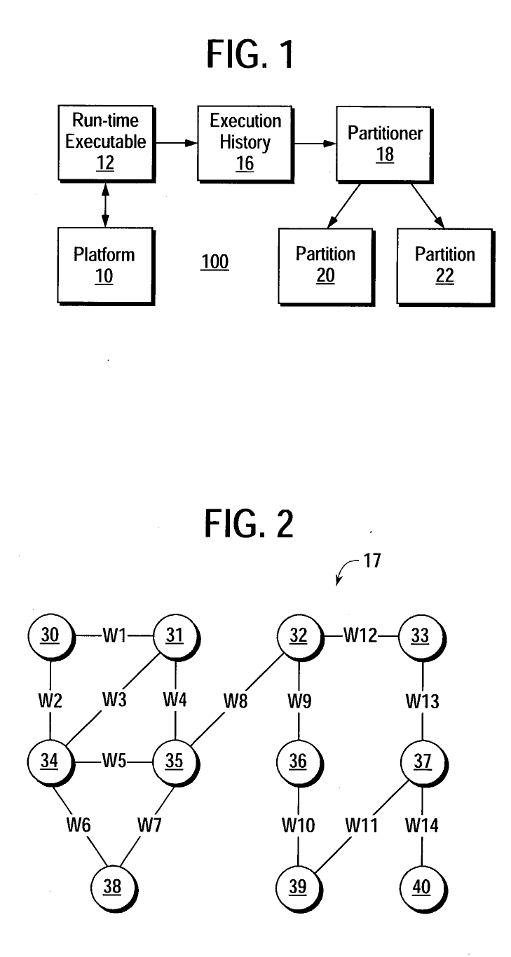

FIG. 1 shows a software execution system 100 that partitions a run-time executable 12 according to the present teachings. The software execution system 100 includes a platform 10 that is capable of executing the run-time executable 12. The platform 10 represents an appropriate set of hardware and software components for executing the run-time executable 12 including processing resources, memory resources, etc., as well as operating system components for supporting the run-time executable 12.

The architecture of the run-time executable 12 is structured as a set of software components in which routines and associated data are encapsulated together. These software components may be referred to as classes, modules, objects, etc. Many of the software components of the run-time executable 12 interact with one another using, for example, function calls that may pass parameters.

For example, the run-time executable 12 may be executable binary code that was compiled from C++ source code—an object-oriented programming language that encapsulates methods and data. In another example, the run-time executable 12 may be Java byte code including components that encapsulate methods and data and execute under a Java Virtual machine contained in the platform 10.

The software execution system 100 records an execution history 16 while executing the run-time executable 12. The execution history 16 provides a record of interactions between the components of the run-time executable 12 along with the characteristics of the interactions. The time window of the execution history 16 is selected so that it may reflect the immediate and past resource demands and predict future resource demands of the run-time executable 12.

A variety of methods may be employed to obtain the information recorded in the execution history 16. It is preferable that the information be obtained in the background while the run-time executable 12 executes without disturbing resource usage or access patterns of the run-time executable 12 significantly. In one embodiment, the software components of the run-time executable 12 are provided with “hooks” to record the pertinent information as execution proceeds. For example, a method call to a software component performs its usual function but a few extra instructions are inserted to record the source and destination of the call into the execution history 16. The executable binary of the run-time executable 12 may be pre-analyzed to detect a bit pattern that indicates a call to a software component and then the binary code for the appropriate instructions that record the pertinent information may be inserted into the executable binary.

In another embodiment, the platform 10 detects a call to a software component of the run-time executable 12 and inserts a record of the source and destination of the call into the execution history 16. For example, the platform 10 may include a virtual machine that executes the run-time executable 12 (which is adapted to the virtual machine) and a component of the virtual machine such as an execution monitor in the virtual machine may provide the pertinent information for the execution history 16.

The software execution system 100 includes a partitioner 18 that exploits the granularity in the structure of the run-time executable 12 when partitioning. The partitioner 18 partitions the run-time executable 12 into multiple partitions response to the execution history 16. For purposes of illustration, the multiple partitions in the following example include a pair of partitions 20-22. Each partition 20-22 includes a subset of the software components of the run-time executable 12. A particular division of the software components of the run-time executable 12 among the partitions 20-22 is referred to as a partitioning of the run-time executable 12. In one embodiment, the partitioner 18 partitions the run-time executable 12 so as to minimize the level of interactions between the partitions 20-22. The partitioner 18 may be implemented as an application program for the platform 10 or may be implemented as part of an run-time system in the platform 10.

FIG. 2 illustrates an execution graph 17 which the partitioner 18 builds from the information contained in the execution history 16. The execution graph 17 includes a set of nodes 30-40 each of which represents a software component of the run-time executable 12. The nodes 30-40 are interconnected by a corresponding set of edges each of which has a corresponding weight w1-w14.

The weights w1-w14 represent a magnitude of interaction between the corresponding software components of the run-time executable 12. The weights w1-w14 may represent the amount of data passed between the corresponding software components or may represent the frequency of interaction between the corresponding software components or a combination of these factors or other factors. For example, the weight w1 may be a combined factor that represents the amount of data passed between the software components associated with the nodes 30 and 31 and the frequency of interaction between the software components associated with the nodes 30 and 31. Such a combined factor is related to a communication bandwidth needed between the software components associated with the nodes 30 and 31.

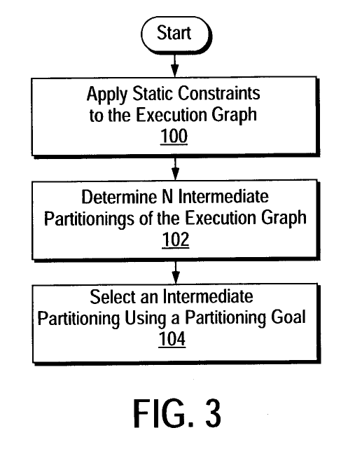

FIG. 3 shows a method for partitioning the run-time executable 12 according to the present techniques. At step 100, the partitioner 18 applies static constraints to the execution graph 17. For example, the software components associated with the nodes 30 and 31 may not be relocatable to another machine. In a virtual machine environment, for example, the software components of the nodes 30 and 31 may be native routines that cannot be readily executed on other computer systems.

At step 102, the partitioner 18 determines N intermediate partitionings of the nodes in the execution graph 17 that did not meet the static constraints applied at step 100. In this example, N equals 9, which is the number of nodes 30-40 minus the two nodes 30 and 31 that cannot be moved. As a consequence, the partitioner 18 determines N=9 intermediate partitionings of the execution graph 17 at step 102.

In one embodiment, the partitioner 18 determines a first intermediate partitioning by initially selecting one of the nodes 32-40 at random—for example the node 33. The partitioner 18 then selects the neighbor of the node 33 having the highest level of mutual interactions as indicated by the corresponding weighted edge and groups them together. For example, if w12 is greater than w13 then the partitioner 18 chooses the neighbor node 32. This results in a first intermediate partitioning with the nodes 32 and 33 grouped together in one partition and the nodes 34-40 grouped together in another partition. The partitioner 18 then chooses the neighbor of the node 32-33 partitioning having the highest level of mutual interactions. For example, the partitioner 18 chooses the node 35 if w8 is greater than w9 or w13. This results in a second intermediate partitioning with the nodes 32 and 33 and 35 together in one partition and the nodes 34 and 36-40 together in another partition. The partitioner 18 repeats this process N times to derive N intermediate partitionings. At step 104, the partitioner 18 selects one of the intermediate partitionings from step 102 based on a partitioning goal. For example, if the partitioning goal is to free 20 percent of the memory of the platform 10 then the partitioner 18 selects the first one of the intermediate partitionings that frees 20 percent of memory. If the first intermediate partitioning meets the partitioning goal then this yields a partitioning in which the software components associated with the nodes 32-33 are assigned to the partition 20 and the software components associated with the nodes 34-40 are assigned to the partition 22. If the second intermediate partitioning meets the partitioning goal then this yields a partitioning in which the software components associated with the nodes 32-33 and 35 are assigned to the partition 20 and the software components associated with the nodes 34 and 36-40 are assigned to the partition 22, etc.

The partitioning goal applied at step 104 may be evaluated in comparison to measurable characteristics of the software components of the run-time executable 12. For example, each software component may be characterized by component size in terms of memory space or by system power consumption when the software component executes.

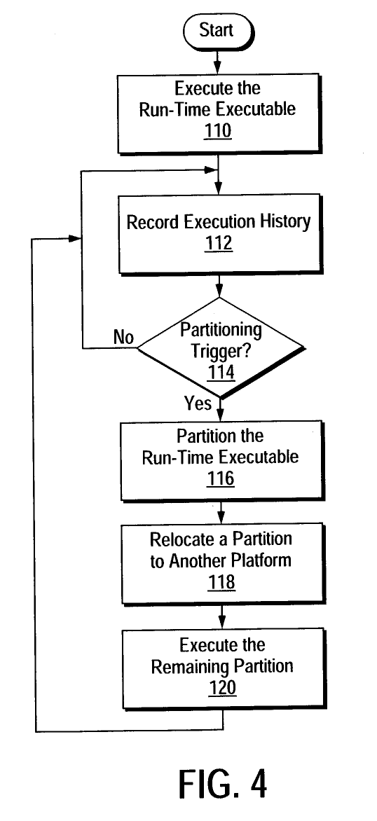

FIG. 4 shows a method for run-time partitioning of the run-time executable 12 according to the present techniques. At step 110, the run-time executable 12 is executed on the platform 10 which may be viewed as an initial computing device. The initial computing device may be a handheld device or a computer system in a distributed system that is to execute one of the resulting partitions 20-22.

At step 112, the execution history 16 is recorded in a manner previously described as the run-time executable 12 executes. At step 114, the platform 10 monitors one or more factors that influence partitioning. For example, the platform 10 may monitor memory usage or power consumption, etc. Steps 112-114 continue until the platform 10 detects a trigger point. One example of a trigger point is when memory usage on the initial computer system exceeds a predetermined threshold. Another example of a trigger point is when power consumption on the initial computer system exceeds a predetermined threshold level.

At step 116 in response to the trigger point, the partitioner 18 partitions the run-time executable 12 into the partitions 20-22 in a manner as previously described with the goal of yielding the partition 20 that remains under the trigger point.

At step 118, the partition 22 is relocated to another platform that is in communication with the platform 10 and that is capable of distributed execution of the partitions 20 and 22.

At step 120, the partition 20 is executed on the platform 10 and monitored and possibly repartitioned using the steps 110-118.

The present techniques enable an entire distributed application to be globally analyzed and globally repartitioned. This process may include the symmetric movement of objects including functions and data between all of the devices involved.

In the case of handheld devices an application may start execution on the handheld device and then spread out to other devices as needed in support of the handheld device. In such a system, the handheld device may be viewed as a master device and the other devices that support the handheld may be viewed as slave devices. In this view, the handheld device is a special device and the overall system is asymmetric. For example, the handheld device may retain native functions and provide a user interface to a user.

In some embodiments, other factors apart from the execution history contained in an execution graph may be used to trigger partitioning. These factors may include an off-line evaluation of the application, developer hints, summaries of previous execution histories, etc.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A method for partitioning a run-time executable, comprising the steps of:
building a graph of an execution history of the run-time executable such that the graph includes a set of nodes each corresponding to a software component of the run-time executable and a set of weighted edges that indicate a level of interaction among the software components;
determining a set of intermediate partitionings of the nodes in response to the weighted edges;
selecting one of the intermediate partitionings that meets a partitioning goal and partitioning the software components accordingly.

2. The method of claim 1, wherein the step of determining a set of intermediate partitionings comprises the step of determining an intermediate partitioning for each of the software components that is re-locatable.

3. The method of claim 2, wherein the step of determining an intermediate partitioning comprises the steps of:
selecting a next node from among the nodes such that the software component corresponding to the next node is re-locatable;
selecting a first node having a highest valued weighted edge from among a subset of the nodes that are neighbors to the next node;
grouping together the next node and the first node.

4. The method of claim 1, further comprising the step of obtaining the execution history while executing the run-time executable.

5. The method of claim 4, wherein the step of obtaining the execution history includes the step of modifying the run-time executable to record interactions among the software components.

6. The method of claim 4, wherein the step of obtaining the execution history includes the step of modifying a runtime system to record interactions among the software components.

7. A software execution system, comprising:
platform for executing a run-time executable;
execution history that provides a record of interactions among a set of components of the run-time executable;
partitioner that partitions the run-time executable into a pair of partitions in response to the execution history by building a graph that includes a set of nodes corresponding to the software components and a set of weighted edges that indicate a level of interaction among the software components and determining a set of intermediate partitionings of the nodes in response to the weighted edges and selecting one of the intermediate partitionings that meets a partitioning goal.

8. The software execution system of claim 7, wherein the run-time executable is structured as a set of software components in which routines and associated data are encapsulated together.

9. The software execution system of claim 7, wherein the run-time executable is executable binary code compiled from C++ source code.

10. The software execution system of claim 7, wherein the run-time executable is Java byte code.

11. The software execution system of claim 7, wherein the execution history is recorded while executing the run-time executable.

12. The software execution system of claim 11, wherein a time window of the execution history is selected such that the record reflects past and immediate resource demands and predict future resource demands of the run-time executable.

13. The software execution system of claim 11, wherein the software components of the run-time executable are provided with hooks that record a set pertinent information for the execution history.

14. The software execution system of claim 11, wherein the platform records the execution history by detecting a call to a software component of the run-time executable and inserting a record of a source and a destination of the call into the execution history.

15. The software execution system of claim 7, wherein the partitioner partitions the run-time executable so as to minimize a level of interaction among the partitions.

16. The software execution system of claim 7, wherein the partitioning goal is based on communication bandwidth.

17. The software execution system of claim 7, wherein the partitioning goal is based on power consumption.

18. A method for run-time partitioning of a run-time executable, comprising the steps of:
executing the run-time executable on an initial computing device;
recording an execution history of interactions among a set of components of the run-time executable as the run-time executable executes;
monitoring one or more factors that influence partitioning and detecting a trigger point;
partitioning the run-time executable into a pair of partitions in response to the execution history by building graph that includes a set of nodes corresponding to the software component and a set of weighted edges that indicate a level of interaction among the software components and determining a set of intermediate partitionings of the nodes in response to the weighted edges and selecting one of the intermediate partitionings in response to the trigger point;
relocating one of the partitions to another computing device.

19. The method of claim 18, wherein the step of detecting a trigger point comprises the step of detecting when resource consumption on the initial computing device exceeds a predetermined threshold.

20. The method of claim 18, wherein the step of detecting a trigger point comprises the step of detecting when memory consumption on the initial computing device exceeds a predetermined threshold.

21. The method of claim 18, wherein the step of detecting a trigger point comprises the step of detecting when power consumption on the initial computing device exceeds a predetermined threshold.

22. A computer-readable storage media that contains a program that when executed by a computer partitions a run-time executable by performing the steps of:
executing the run-time executable on an initial computing device;
recording an execution history of interactions among a set of components of the run-time executable as the run-time executable executes;
monitoring one or more factors that influence partitioning and detecting a trigger point;
partitioning the run-time executable into a pair of partitions in response to the execution history by building graph that includes a set of nodes corresponding to the software component and a set of weighted edges that indicate a level of interaction among the software components and determining a set of intermediate partitionings of the nodes in response to the weighted edges and selecting one of the intermediate partitionings in response to the trigger point;
relocating one of the partitions to another computing device.

23. The computer-readable storage media of claim 22, wherein the step of detecting a trigger point comprises the step of detecting when resource consumption on the initial computing device exceeds a predetermined threshold.

24. The computer-readable storage media of claim 22, wherein the step of detecting a trigger point comprises the step of detecting when memory consumption on the initial computing device exceeds a predetermined threshold.

25. The computer-readable storage media of claim 22, wherein the step of detecting a trigger point comprises the step of detecting when power consumption on the initial computing device exceeds a predetermined threshold.
